(19) United States
(12) Patent Application Publication
(10) Pub. No.: US 2021/0295458 A1
(43) Pub. Date: Sep. 23, 2021

(54) SYSTEM AND METHOD FOR ONLINE PROPERTY RENTAL LISTINGS WITH AUTOMATED PRICING AND INCOME ADJUSTMENTS AND A GRAPHICAL USER INTERFACE

(71) Applicant: Marquis Founders LLC, New York, NY (US)

(72) Inventors: Alex Goldstein, Melville, NY (US); Bryan Fedner, New York, NY (US); Wesam Saif, Livermore, CA (US)

(21) Appl. No.: 16/824,449

(22) Filed: Mar. 19, 2020

(51) Int. Cl. G06Q 50/16; G06Q 30/06; G06Q 30/02

(52) U.S. Cl. CPC G06Q 50/163; G06Q 30/0283; G06Q 30/0645

(57) ABSTRACT

A system for and method of providing a listing of available rental properties in a particular area, and an improved graphical user interface for viewing and management of the listed properties. The system/method automatically adjusts pricing for different time rental periods for different months when the rules are modified for a Reference Month or a “driver period” within a month. It automatically calculates and populates nightly calendar pricing and formulas or percentage relationships for different rental periods in each month and recalculates estimated monthly income based on the dynamic changes that the owner may enter for the owner's income goals, availability of the property, Premium Night rates, minimum length of stay, minimum monthly income and other parameters.

### TECHNICAL FIELD

The present invention relates to a system and method for placement and management of rental properties through an automated online portal, and for an automated rental property pricing adjustment system that is better suited to meet owners' financial goals for seasonal, temporary or high-demand periodic rentals of their properties.

### BACKGROUND

There are currently several online rental systems that allow property owners to list their vacation and short-term rental properties, where renters can access the listings and select the desired rental property for a specified period or duration. For example, AirBnB (www.airbnb.com) and Vacation Rentals by Owner (www.vrbo.com) allow owners to list their properties in the online listings, accessible to renters.

In these systems, the renters may view photographs or conduct a “virtual tour” by viewing a short interactive video showing the listed property and then select a particular listed property for an indicated minimal rental duration period, for the specific dates when the property is still available. However, these systems are not well-tailored to accommodate specific rental objectives of the property owners. Furthermore, they do not provide an automated dynamic pricing adjustment system that can quickly and efficiently adjust and recalculate the pricing strategy for the owner when he or she changes a particular parameter or a pricing goal for the property.

### SUMMARY OF THE INVENTION

The present invention meets the demands for a system and method that is more tailored to the specific rental objectives and financial goals of the property owners, and can utilize the market information and dynamic pricing strategy for every property and every owner, particularly for properties in an area with wider price fluctuations during high-demand time periods (for example, during holidays or vacation time) or around specific time periods and/or events.

In one or more embodiments, the present invention includes a computerized and automated system and method for providing a listing of available rental properties in a particular geographic area, and for an improved graphical user interface for viewing properties and management of the listed properties by the property owners or rental management agencies.

The present system, in some embodiments, also provides an enhanced user interface that accommodates and allows faster and more efficient management and settings for the property availability, setting certain rules for the pricing and estimated rental revenues for different rental periods.

Among other features, some embodiments of the present invention implement one or more combination of the following features: (a) providing and processing user entries for the Monthly, Two-week, Week, Weekend and Mid-week pricing settings for each month; (b) automated settings and population of the pricing for the Reference Month, based on the user entry for the Reference Month entry (or entries); (c) calculation of the Relationship Template based on the percentages for different time entries in the Reference Month; (d) automated setting and population of the pricing for the non-Reference Months based on the determined Relationship Template for the Reference Month and/or based on the “driver” entry; (e) implementation of the “monthly weights” feature and calculations and adjustments in price for different months (and different time period entries in each month) in a rental period; (f) implementation of a Premium Nights pricing feature, calculations and adjustments in price for various time entries based on the Premium Nights prices; (g) implementation of a Length of Stay (LOS) Discount feature, calculations and adjustment in price for different time entries based on the LOS discounts; (h) implementation of a settable Minimum Allowable Duration (MAD) time period, automatic calculations and adjustments in price for different time entries based on the set MAD value; (i) implementation of a settable Minimum Rental Value (MRV) feature, automatic calculations and adjustments in price for the different time entries based on the specified MRV value; (j) implementation of a settable Minimum Monthly Income (MMI) feature, automatic calculations and adjustments in price for the different time entries based on the specified MMI value; (k) implementation of a manually settable and adjustable calendar display for each month in the allowed rental period, with indicators of calculated Nightly Rates, Premium Nights indicators, and Minimum LOS on the monthly calendar; (l) implementation of a suggested price or rate feature based on the market data and Relationship Template; (m) implementation of an allowable duration indicator in the settable display options for each month; (n) implementation of a “blocked month” setting feature; (o) implementation of an adjustable pricing strategy that allows the owner to set the weekend pricing that equates to the intended revenue goals for a week, 2-week or a month period; (p) implementation of an automated Monthly Income recalculations based on the applicable user changes to values or various user-settable and modifiable parameters; and (q) providing an auto-notification and on-screen notice for the user when the Automated Price Strategy Tool determines that the minimum length of stay (LOS) set by the user for a particular day or time period makes a check-in impossible because of a blocked date that interferes with the set LOS requirement.

These and other beneficial features and advantages of the present invention are disclosed in detail hereinafter with reference to the accompanying drawings and descriptive matter in each embodiment.

### BRIEF DESCRIPTION OF THE DRAWINGS

FIG. 1 illustrates a diagram of the general process for the owner to create a property listing in accordance with one or more embodiments of the present invention.

FIG. 2 illustrates organization of the property listing information and data in accordance with one or more embodiments of the present invention.

FIG. 3 illustrates set up of one or more parameters for the property listing in accordance with one or more embodiments of the present invention.

FIG. 4 illustrates a general diagram of the system and organization of some components of the system for processing and creation of the property listings in accordance with one or more embodiments of the present invention.

FIG. 5 illustrates an example of a Relationship Template used for different time period entries for a Reference Month in accordance with one or more embodiments of the present invention.

FIG. 6 illustrates automated settings that are set for different months and timer periods in each month, based on the Relationship Template settings for the time periods entered for the Reference Month in accordance with one or more embodiments of the present invention.

FIG. 7A illustrates an example of the automated settings and calculations for the non-Reference Month time period entries based on the Relationship Template entered for the Reference Month in accordance with one or more embodiments of the present invention.

FIG. 7B illustrates an example of the full calendar, with daily rates calculated for the non-Reference Month based on the Relationship Template entered for the Reference Month in accordance with one or more embodiments of the present invention.

FIG. 8 illustrates an example of a Length of Stay Discount feature in accordance with one or more embodiments of the present invention.

FIGS. 9A-B illustrate an example of the Length of Stay Discount calculations for a specific rental period in accordance with one or more embodiments of the present invention.

FIG. 10 illustrates examples of calculations and adjustable settings for a Premium Nights feature in accordance with one or more embodiments of the present invention.

FIG. 11 illustrates an example of a Minimum Rental Value Setting feature in accordance with one or more embodiments of the present invention.

FIG. 12 illustrates an example of a driver entry for a particular time interval setting in a specific Month entry in accordance with one or more embodiments of the present invention.

### DETAILED DESCRIPTION OF THE INVENTION

Among many other areas, the present invention may serve and be used for the high-demand vacation areas, like the Hamptons and other Long Island, N.Y. areas that have much higher rental demand and potential rental returns during certain summer months, and require a more specialized approach to renting properties than simply listing a property at a fixed price. Moreover, the present invention, in several embodiments, accommodates renters who want to rent properties for only a short period of time and want to see properties even if they do not fully fit or match the desired rental time period. The present invention also allows users to view properties that may overlap some of the time when a rental is desired, but are not available for the full time period for which the renter might be initially searching.

The present invention, in some embodiments, automatically adjusts the pricing for different rental time periods and for different months when the rules are modified by the owner for a Reference Month and/or a “driver period” time entry within a non-Reference month. This is utilized to automatically calculate and populate the pricing and formulas and/or percentage relationships for the other time interval periods in each month (i.e., price entries for other months).

The present invention also provides, in one or more embodiments, a computerized and automated system and method for optimizing the property owner's financial goals and objectives for the property rentals. For example, it allows the owner to set the weekend pricing during a particular month in a way that maximizes the expected revenue and may equate to the intended revenue goals for a week, 2-week or the whole monthly rental period.

In some embodiments, the present invention further provides automated maintenance and pricing adjustments, which are based on the dynamic changes and adjustments of the owner's goals, parameters, availability and secured rentals for the same property during high-demand rental periods. The operation and implementation of various embodiments and exemplary features are discussed below, with reference to specific examples and figures.

### Definitions

“Reference Month” is the highest expected rental revenue month for the property in a selected availability date range and a property local area. For example, the month of August may be considered the highest expected rental revenue month for rentals in the Hamptons on Long Island, N.Y. Thus, in accordance with at least one embodiment, the month of August or another highest expected monthly rental revenue is selected as a Reference Month.

“Standard Nightly Rate” is the daily rental amount for a specific date. In some embodiments, if the specific date is a weekend, the “standard nightly rate” (daily rate for that day) is the weekend rate divided by two. In other exemplary embodiments, the date may be set to one of two (or possibly more) mid-week days. In one example, the midweek is one of two days from Wed.-Fri., and the daily rate is the Midweek rate divided by two.

“Premium Nights” refers to a daily rental amount for the night(s)/day(s) that are in high demand. For example, the daily rental for the 4^{th} of July weekend may be in particularly high demand. In another example, if there is a sports event, tournament, political convention, concert or business gathering at some specific geographic location, the daily rentals during this period are considered Premium Nights, and may have higher rental rates and rental revenue goals than the Standard Nightly Rate for the same property.

“Adjusted Rate” refers to a night rate that a user has manually changed by entering a specific rate for the time period.

“Nightly Rate” refers to a Standard Nightly Rate, after the adjustments have been applied, such as the Premium Night increase or the user-entered Adjusted Rate. In other words, the term Nightly Rate refers to the final calculated rate, after accounting for the adjustments, discounts and user-entered manual changes and/or settings.

Any listed property will have a Net or Gross income settings. Based on this setting, the user enters either the profits (the amount earned after calculation and adjustment for the listing fees) or revenue (the amount earned before adjustment for the listing fees) in the Pricing Strategy Tool. The estimated profits or revenue will be referenced to as the “Income” for the listed property.

Property Listing Registration and Set-up

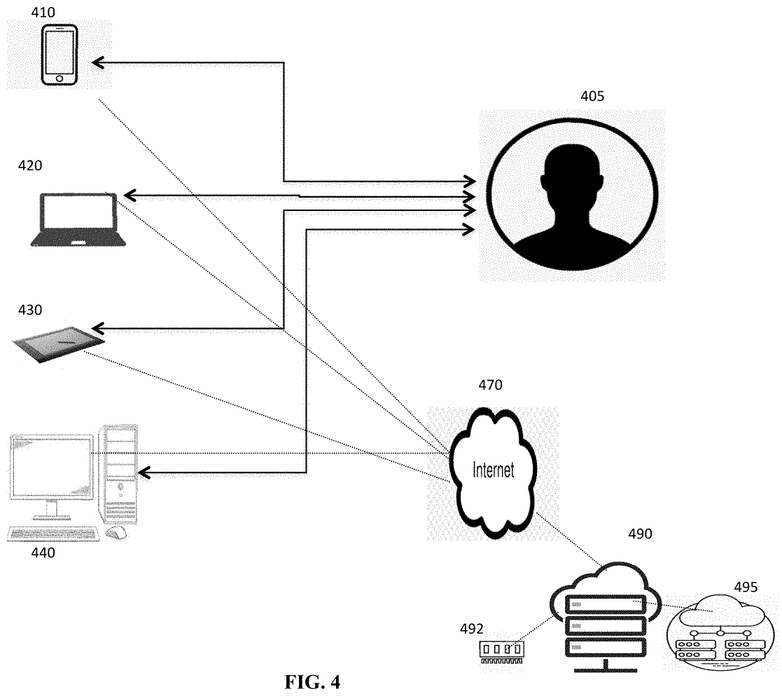

Referring to FIG. 4, a property owner or owner's authorized agent (also referred to in this application as the “user”) 405, who wants to list a particular rental property with a listing service provide, may follow the process in accordance with one or more embodiments of the present invention.

First, the user 405 creates an account and provides personal contact information using a computer processor operating on a user's processor device, which can be a mobile phone 410, a laptop 420, an electronic pad 430, a desktop 440, a TV set equipped with Internet access (not shown) or any other computerized device that includes a computer with a processor that executes computer instructions stored in the computer memory or external memory of the processor device, and can communicate with the processor(s) on the server 490 of the listing service provider over the Internet 470.

The server (or multiple servers) 490 of the listing service provider operates one or more processors, each equipped with an internal computer memory 492, and which communicate(s) with the user's processor device via HTML, XML, or other known communication protocols that are commonly used for communication and exchange of data over the Internet. The server 490 may store property listing data provided by the user either in a local memory 492 or in a database 495 (which can be distributed and/or cloud-based). The database 495 may store individual property data and/or calculated pricing information, and can be accessible to the processor(s) on the server(s) 490 either through the Internet, LAN or any other computer network. The property listing data may also be stored in the external or internal memory of one or more servers 490 of the property listing provider. It is also understood that the transmission of the information, data and images between the user processor device and the server(s) 490 may be done as MMS messages or other known communication and data transmission protocols. Moreover, the server(s) 490 may be a single central server or a network of different servers connected over a LAN, WAN, Internet or any other type of computer network.

The user 405 logs in and sets up an account on the server(s) 490 of the listing service provider over the Internet 470, or through another network, and creates a property listing. In some embodiments, the property listing includes such information as general property details, features, and amenities. For example, it may in include the property address, location and distance to transportation or town, number of bedrooms, number of bathrooms, number of persons that can occupy the property, special features, availability of a beach access or community pool access, handicap access, pool on the property (if any), payment requirements and conditions, restrictions on rentals and use, etc. . . . . The listing may include photographs of the property, short videos or specialized 360 degree interactive videos that allow users to view each room from every angle, and to conduct a “virtual tour” of the listed property.

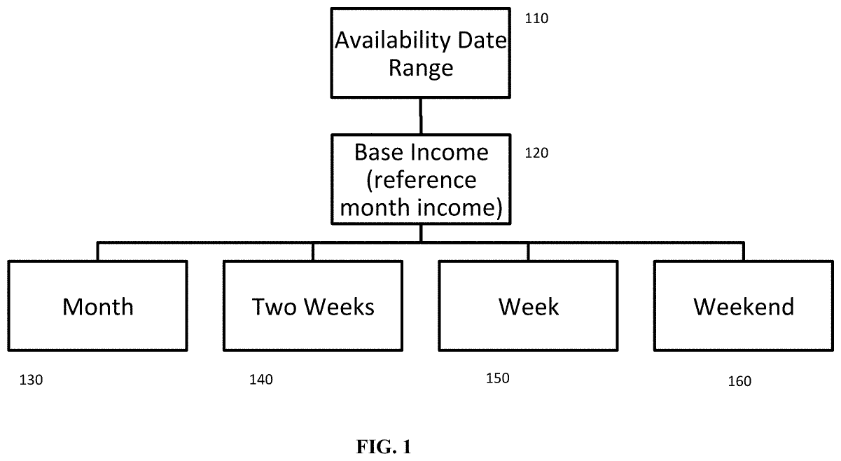

The operation of a Pricing Strategy Tool or feature of one or more embodiments is described with reference to FIGS. 1-12. The Pricing Strategy Tool or feature is provided by a processor operating a Pricing Strategy Tools software on the server 490, to determine and automatically populate appropriate pricing entries. It allows setting of other user-definable and modifiable features and entries used in one or more embodiments of the invention.

Several examples of the Price Strategy Tool and other features are described in the exemplary embodiments described below.

### Example 1 of the Price Strategy Tool

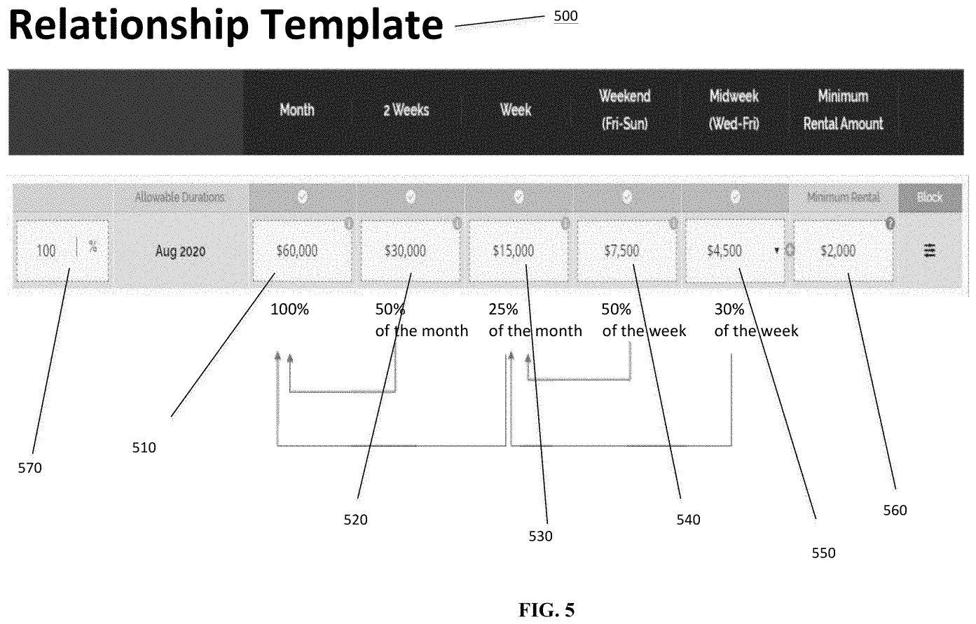

In one example, a user may submit a listing for a rental property in the Hamptons, N.Y., and set his or her goal for optimizing and managing pricing and expected Income for the property. Because the month of August is the highest estimated income rental month in the Hamptons, the user will enter one or more prices for the time entries 510-550 for the month of August, as discussed with reference to FIG. 5. The computerized system will fill in certain defaults in the Relationship Template for the month of August, based on the user's entry. For example, the user may enter or change (from a default value) the Week price value for August, 2020, and the system will automatically change the other price entries based on the evaluated market analysis data provided by the listing services provider or some independent market study. Alternatively, the user may manually enter and change all the price entries 510-550 for the month of August, 2020—the Reference Month in one or more embodiments—in order to better fit the user's rental and Income goals for the property and appropriately set prices for other rental months.

As a result, the set relationship of the entries 510 through 550 will define the Relationship Template not only for August, 2020, but will also apply to other months in the rental period. The changed price values entered by the user for the Reference Month causes the system to automatically recalculate the relationship between different time periods in the Relationship Template for the Reference Month and also apply these relationship to all other months for which the property is rented.

The user may then modify the relationship for the Reference Month, which will automatically update the relationships for other months. In addition, the user may change entries for specific months, other than Reference Month, which will utilize different relationships between time entries for the changed month, but will not apply the changes to other months.

In the described example, the Relationship Template is created for a particular geographic real estate rental market, such as the Hamptons. In accordance with present invention, multiple different Relationship Templates may be created for different geographic markets, or different types of properties in the same geographic area.

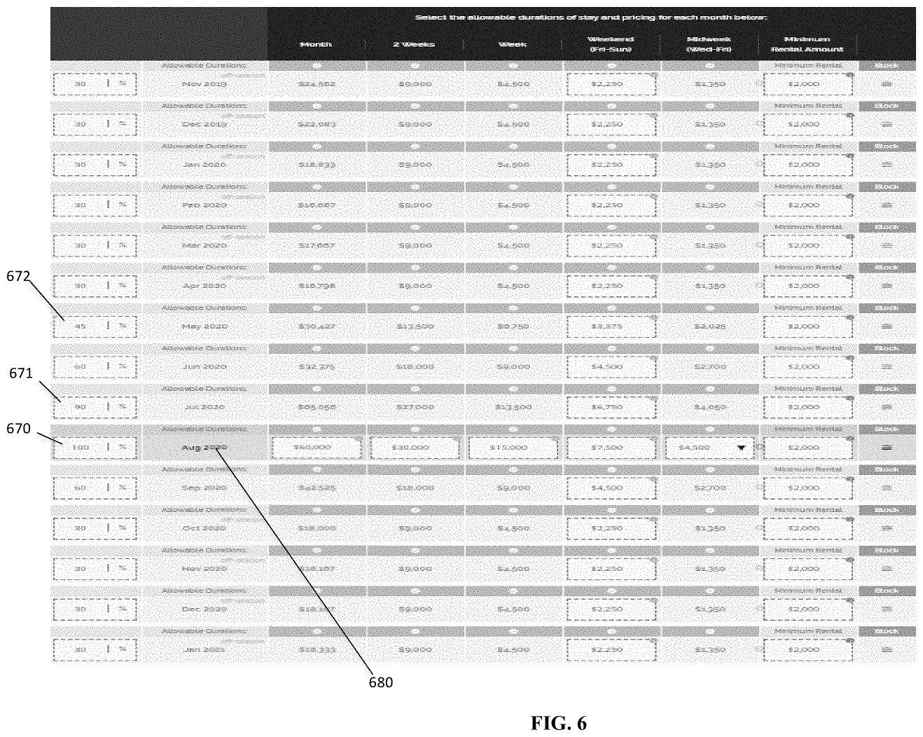

FIG. 6 illustrates an example of how the prices are recalculated for the whole year based on the Relationship Template entered for the Reference Month 680 (August, 2020). In this exemplary embodiment, each non-Reference Month is a certain percentage of the total estimated Income for the Reference Month 680, and the percentage is based on the market data for the Hamptons area, collected by the listing services provider. For instance, the month of July 2020 is 90% of the estimated monthly Income for the month of August, 2020, and the month of May is 45% of the estimated monthly Income for August 2020, as shown in the populated percentages entries 671 and 672 for July and May, 2020, respectively.

In this example, the same relationship or the price ratio of a Weekend to a Week time period entered for the Reference Month 680 (August 2020) is maintained and automatically populated for the corresponding entries for other months. This allows the user to apply the same relationship or ratio for different rental time periods entered for August 2020 (the Reference Month) to all other months when the property is available.

Premium Nights

In addition, the month of July, 2020 includes some high demand rental dates, such as, for example, the July 4^{th} weekend. These high-demand days are assigned a higher price rate, referred to as a Premium Nights feature. The Premium Nights feature is specific to each month, and may depend on holiday weekends or certain dates of higher demand, when the owner may be expected to charge higher rates. For example, the daily rental for the 4^{th} of July weekend may be in particularly high demand in the Hamptons area, and the Sundance Film Festival days may have higher demand in the Park City area. In another example, if there is some sports event or a tournament, political convention, concert or business gathering at some specific geographic location, the daily rentals during this period may be at higher estimated rental rates due to higher demand. Among other methods described here, the higher price rates can be estimated based on the market data and actual rentals in the prior years.

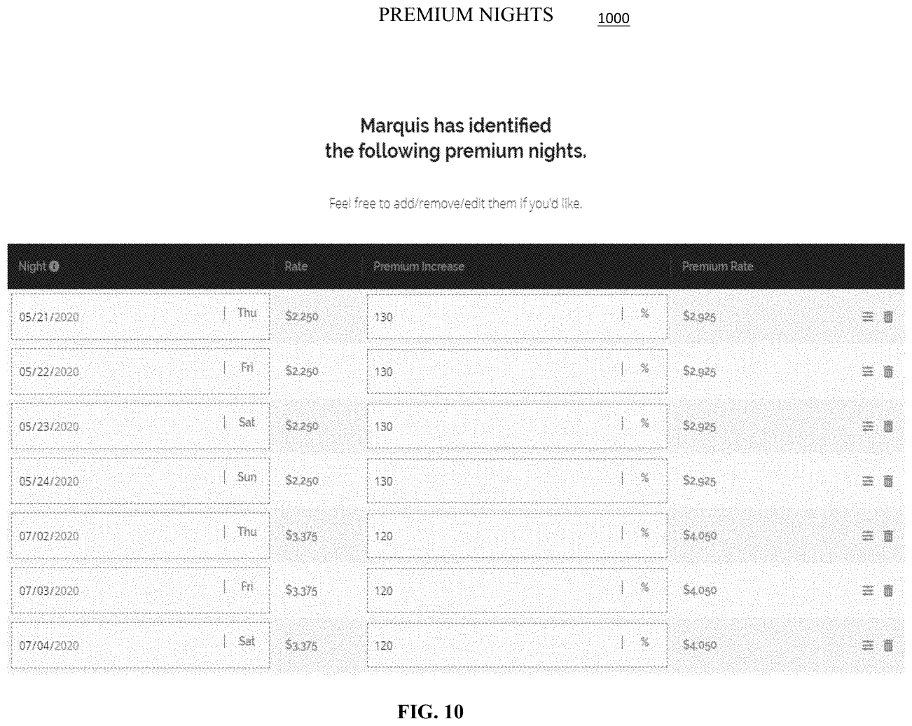

The Pricing Strategy Tool may evaluate the market data and demand data for the property or similar properties in a particular area during similar periods in the past and identify certain dates (for example, holiday weekends) as Premium Nights, as indicated in FIG. 10. The Pricing Strategy Tool may populate and apply the expected rental price percentage increases due to increased demand for the Premium Nights in the pricing model for the month, and readjust the estimated or goal Income for the month based on higher Income and prices for the Premium Nights.

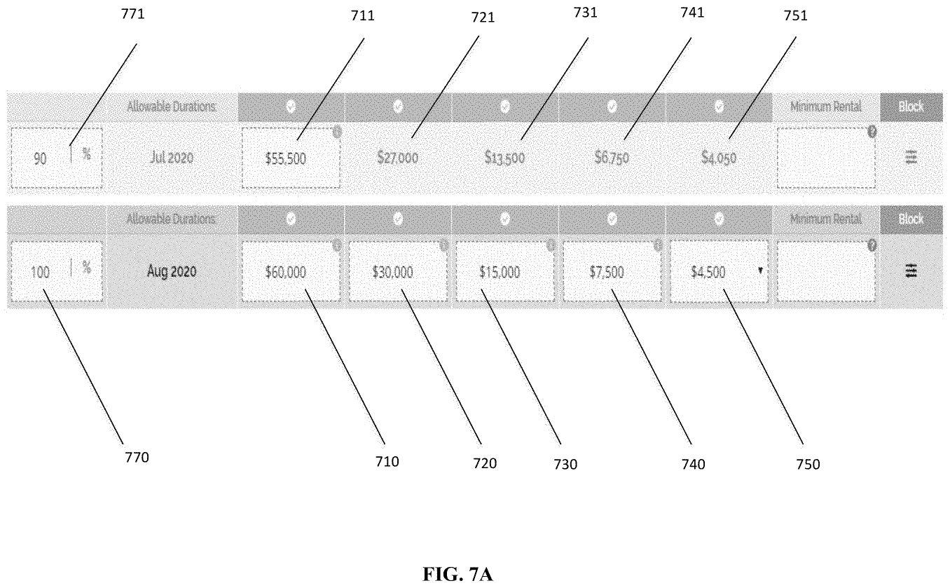

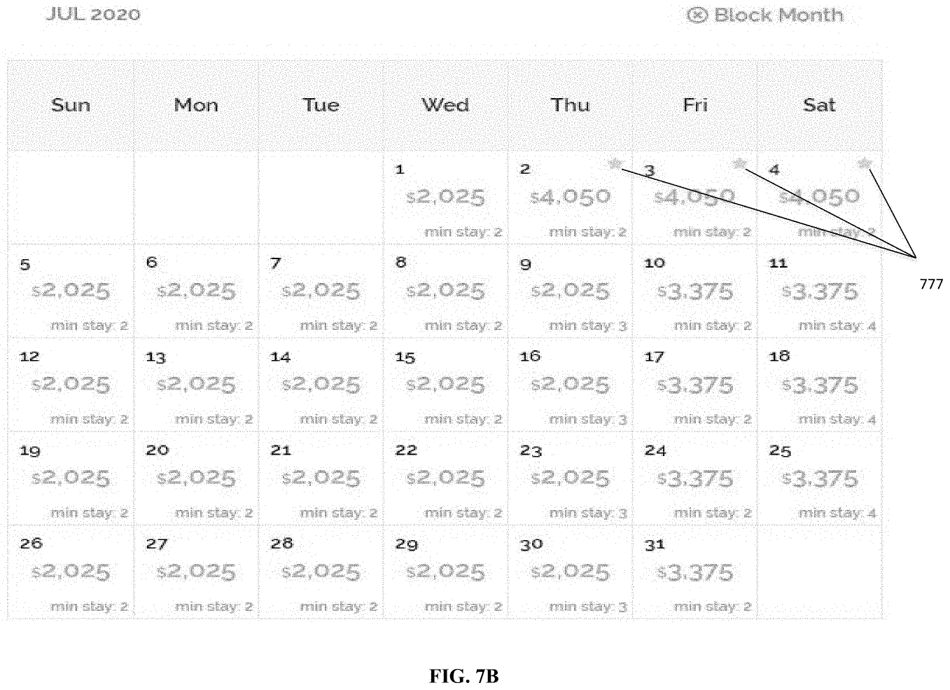

Thus, as illustrated in FIG. 7A, because there is a Premium Night charge for the 4^{th} of July weekend, and because the rentals for the Premium Nights are very likely to be fully booked, the total estimated Income for the Month entry 711 for July 2020 is estimated higher than 90% of the total estimated Income for the month of August entry 710. The other ratios, for the other prices for different time periods (720, 730, 740 and 750 for August and 721, 731, 741 and 751 for July) correspond for both months.

In one or more embodiments, the Premium Night Pricing may be automatically updated for other months (other than the Reference Month) based on the Relationship Template for the Reference Month. In other embodiments, the Premium Night prices are not automatically modified based on the changes in the Relationship Template for the Reference Month, but may be manually changed by the user.

As illustrated in FIG. 7A, the relationships of the prices for the time periods 721, 731, 741 and 751 for July 2020 reflect the percentages and relationship of the corresponding time entries 720, 730, 740 and 750 for the month of August 2020. For instance, the Weekend price for August 2020 is $7,500, which is 50% of the Week price of $15,000 for August 2020. Similarly, the Weekend price for July 2020 is $6,750, which is 50% of the Week price of $13,500 for July 2020. This allows the user to automatically apply the relationship or pricing goals set in the Price Strategy Tool for the Reference Month to all other months, and also adjust expected Monthly Income based on the Premium Prices that are specific to a particular month.

In at least one embodiment, the user may set the weekend pricing or Premium Nights that equates to the intended revenue goals for a week, 2-week or a month period. Thus, the user may manipulate and set very specific revenue goals for some weekends or high-demand Premium Nights, and may reach those goals as the minimum income set goal for the month, 2-week or week period. The time periods are exemplary, and the setting that is used by the user for a shorter time period may also reflect revenue goals for any other, longer time period.

The automatic changes to the time periods for July 2020 (based on the Relationship Template) are then applied to the full calendar for July 2020, applying recalculated rates for each day in that month, as shown in FIG. 7B. First, based on the market data, the estimated rentals in July 2020 are taken as a 90% percentage entry 770 of the Reference Month. In at least one embodiment, this percentage or ratio is applied to all time entries for July, except the Month entry because the Month entry is the “driver” entry. In other embodiments, the percentage or ratios set in the Relationship Template based on the Reference Month may be applied to all entries for other months, including the Month entry.

Thus, the Pricing Tool software takes the value of an August Week entry 730 ($15,000) and calculates 90% of that value, and populates the Week entry 731 for July with value $13,500. Following the Relationship Template, the Pricing Strategy Tool takes 50% of $13, 500 to determine and set the Weekend value to $6,750. On the corresponding monthly calendar, the Friday rate is $3,375 and Saturday rate is $3,375. Then, the Pricing Strategy Tool takes 30% of $13,500 to determine and set the Midweek value to $4,050 (for two midweek days —$2,025 for any one of the midweek days). On the corresponding monthly calendar, the midweek days are set to $2,025 rate. The high-demand or Premium Nights 777 for the month of July are set to a higher rate of $4,050. The calendar view may indicate the Premium Nights using an asterisk or some other indicator. The view may also include the minimum stay information for each day of the month, indicating a restriction on Minimum Length of Stay for each specific time period during the month.

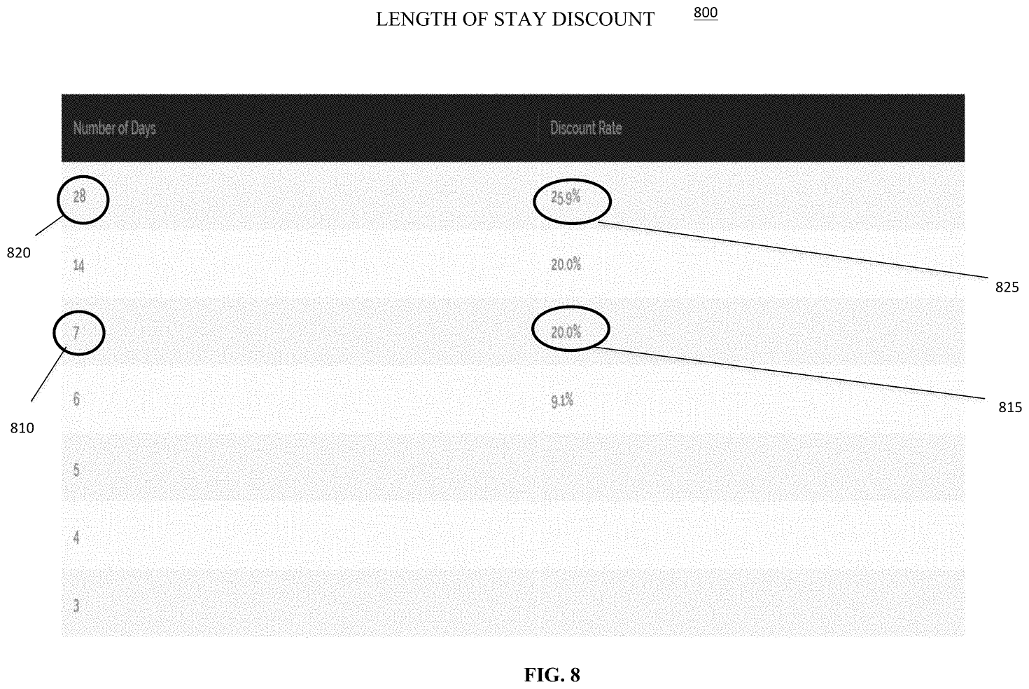

In one or more embodiments the system and may calculate the total estimated or goal Income for the month of July 2020 from the calendar values for each day shown in FIG. 7B, apply the Length of Stay Discount (described in more details below with reference to FIG. 8) and determine the total estimated Income for the month of July 2020, and populate entry 710 ($55,500) in FIG. 7A accordingly. Thus, in some embodiments, the Month entry for a month may be calculated not exclusively or directly based on the Relationship Template or the percentage of a Month entry for the Reference Month. In this example, it is set to $55,500, which is not 90% of $60,000 value for August. It is also not set to 200% of the Two-week entry value calculated for July 2020 ($27,000).

These and other features of the present invention are described more below, with reference to more embodiments of the present invention.

Availability Duration Data

Referring back to FIG. 1, after connecting to the Price Strategy Tool, the user may select the Availability Date Range 110 for the rental property. The availability data is utilized and processed by the listing service provider's processor (executing software) to set the available date range for the rental property. For example, in some embodiments, the user may select and/or enter the start and end dates the listed property is available for rent. These dates can be changed at any point of the process and updated on subsequent user-initiated changes or updates. In other embodiments, the user may set the start date and enter the time period for which the property is available after the start date.

Reference Month

Referring to FIG. 1, after selecting the availability range, in some embodiments, the system requests the user to enter the Base Income 120 that he or she want to charge for the Reference Month. The determination which of the months (in the annual period) should be the Reference Month may be determined based on the market analysis for the local area and rentals in the area where the rental property is located in the selected date range. For example, in the Hamptons (NY) area, in the date range from January 1^{st} to December 31^{st}, the highest revenue month is August, which is taken as the Reference Month. In Hudson Valley, the Reference Month may be December because that is the highest revenue month based on the relevant market studies. In some embodiments, the present invention selects the Reference Month based on the market study of rental values and average rental values for the properties in the local area during prior years. The actual rental data may come from a number of different sources.

In one or more embodiments, there may be a separate Reference Month and a different Relationship Template for different geographic areas, different local areas or different types of properties within a particular area. For example, in some embodiments, the present system may utilize a different Reference Month and/or a different Relationship Template for the oceanfront properties than for other nearby inland properties.

Minimum Length of Stay

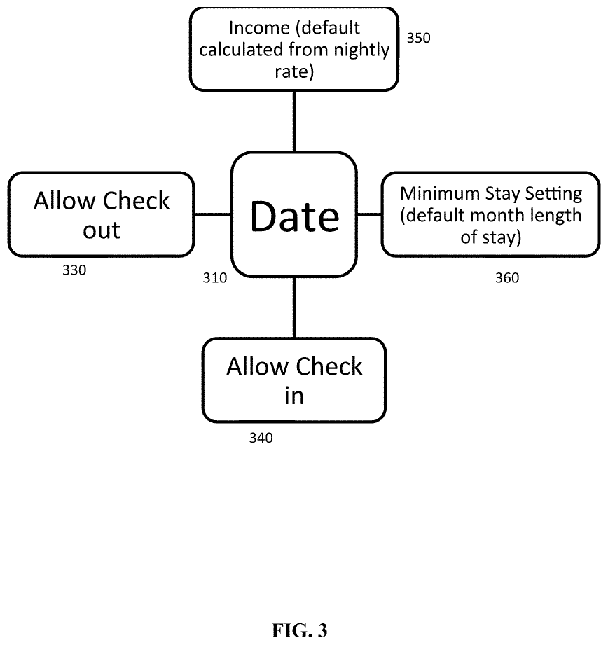

The user may also select a Minimum Length of Stay (360 in FIG. 3) that the user would accept for the month. For example, the user can select a Two-week booking minimum length of stay for the month of January or a Weekend booking for the month of July. The user can also enter a custom Minimum Length of Stay for the month by typing the number of nights instead of selecting a pre-defined option for the Minimum Length of Stay.

In some embodiments, the system may apply some default values for the Minimum Length of Stay setting, such as, for example, a minimum of one-month stay, a two-week or a week stay for either the particular listed property or multiple properties in the same area. Then, the user may manually change the default Minimum Length of Stay settings (set by the system) for different months or other times periods based on the user preferences.

The monthly length stay settings define the minimum nights a booking must have when it starts during the month. Each night can have a Minimum Length of Stay associated setting, independently from the monthly setting. In other embodiments, other time entries (i.e., the week, two-week, weekend, etc.) may also have a Minimum Length of Stay associated setting, which is initially automatically set by the system and can then be modified by the user.

Income Setting for Each Time Period in a Month

In one or more embodiments, after the user selects the length of stay for any given month, he or she can enter the estimated Income goal for the bookings in the allowable length of stay. For example, the user may enter an estimate or a goal for the total Income for a month in the Month entry 130 for the property in the Pricing Strategy Tool. Similarly, the user may enter an estimate or a goal total Income for the Two-week entry 140 (14 nights), the Week entry 130 (7 nights) and/or the Weekend entry 160. In some embodiments, the Weekend entry may be Friday-Sunday booking (with a check-in on Friday and a check-out on Sunday).

Referring to FIG. 5, in addition to the settings 510-540 for the Month, Two-week, Week and Weekend time period settings, the user may also enter a Midweek estimated Income goal 550 for the property. In other embodiments, the Midweek estimated Income goal may be automatically set based on the difference between the Week entry and the Weekend entry set by the user or automatically populated by the system.

It is understood that the described time periods are exemplary in nature, and that other rental time periods may also be utilized and applied in similar fashion in accordance with one or more embodiments of the present invention.

Relationship Template

In one or more embodiments, the Pricing Strategy Tool may utilize certain default values, which are calculated for the Reference Month based on the user's Income goal for that Month entry. This is described as the Relationship Template in the example shown in FIG. 5. For example, for the rentals in the Hamptons, N.Y., the month of August 2020 is taken as the Reference Month based on the market data. The use then may enter the amount of Income (goal) for the entire month 510 (shown as $60,000) for the rental property.

Thus, the month income entry for the Reference Month is the “driver”, and other time entries for the Reference Month may be automatically calculated based on the month income and the market analysis data. Accordingly, the system may automatically calculate and populate other duration period entries, such as the Two-week entry 520, Week entry 530, Weekend entry 540 and Midweek entry 550, based on the user's entry for the Month time period and based on the market analysis data that may be obtained and/or applied by the server of the listing services provider. As illustrated, the Two-week expected Income entry 520 default Income goal or expected rent is $30,000, or 50% of the monthly Income specified by the user for the Month entry 510. The Week entry 520 is automatically populated with the goal or expected Income value $15,000, which is 25% of the Month entry entered by the user.

The Weekend entry 540 may be automatically pre-set to $7,500, which is 50% of the Week entry 530, calculated based on the market studies or the set default value provided by the rental listing service provider and/or independent market studies for the relevant rental market. The Midweek entry 550 (Wed-Fri) may be set to $4,500, which is 30% of the Week 530 calculated or pre-set entry, also based on the market studies or the default value provided by the rental listing service provider and/or independent market studies (or both).

In accordance with one or more embodiments, the user may change or modify any entry in the Relationship Template for different time periods illustrated in FIG. 5. In other words, the user may enter different Income goals for the Two-week entry 520, which is not 50% of the Month entry 510. The user may set a higher or lower percentage relationship for the shorter stays; not proportional to the overall Month entry 510. Similarly, the user may also modify the Week entry 530 to be something other than 25% of the entire month Income goal. Moreover, the minimum amounts and the underlying 50% relationship can also be modified by the user for the Weekend entry 540 and the Midweek entry 550. The ability to modify the relationships and settings is important in the areas that have very high seasonal demand and strict town ordinances, like the properties in the Hamptons, seaside resorts near major cities, Oceanside resorts, and/or towns or cities hosting seasonal reoccurring events, like major tennis tournaments, championships, etc.

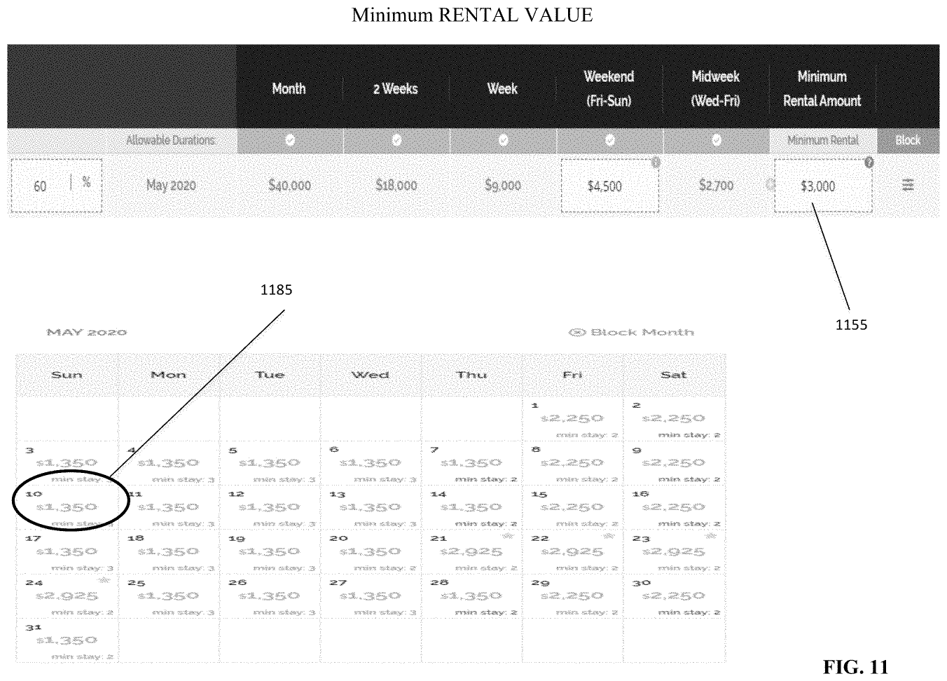

The user may also set a Minimum Rental Amount entry 560 to what he or she requires. The Minimum Rental Amount feature of the present invention is discussed in more detail below, with reference to FIG. 11.

Automatic Calculation/Recalculation for the Non-Reference Months

After the user identifies and enters Income values for the Reference Month, the initial Income values are pre-calculated and set, and the user is presented with modifiable entries for the Income values and length of stay settings for each month in the selected date range of the available rental, based on the ratio and relationships specified in the Relationship Template (for example, different time entries for the Reference Month).

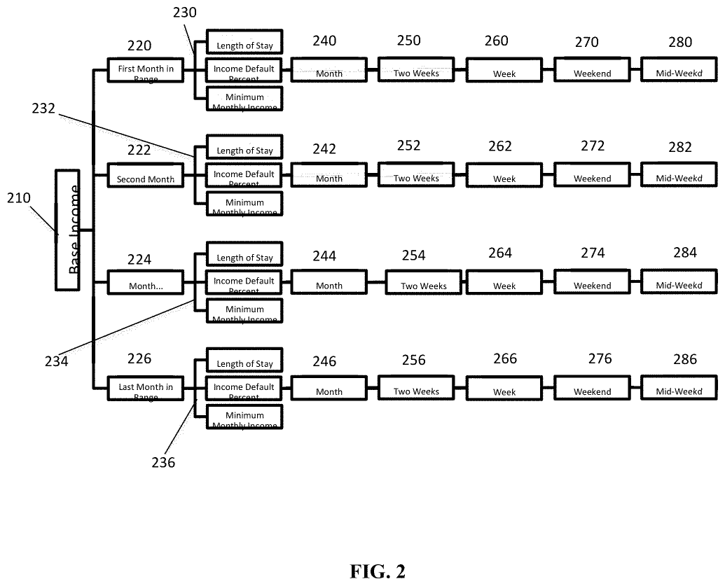

Referring to FIG. 2, the entries that the user enters into the Relationship Template (i.e., the Reference Month entries in some embodiments) will be carried out for each of the four months 220, 222, 224 and 226, for the specified or calculated allowable rental time period. Thus, the relationships or ratios in the Income goal for (a) the Two-week entry to the Month entry, (b) the Week entry to the Month entry, (c) the Weekend entry to the Week entry, and/or (d) the Midweek entry to the Week entry for the Reference Month will be automatically carried out and calculated for all months (220, 222, 224 and 226) in the rental availability range.

For example, in one or more embodiments, if the user or system has entered certain values for the month 220 and populated the Month entry 240, the Two-week entry 250, the Week entry 260, the Weekend entry 270 and the Midweek entry 280 in a certain relationship or ratio, the same relationship or ratio between the estimated Income for different time interval entries may be automatically calculated for the second month 222 and its corresponding time interval Income entries 242, 252, 262, 272 and 282, the third month 224 and its corresponding time interval Income entries 244, 254, 264, 274 and 284, and the fourth month 226 and its corresponding time interval Income entries 246, 256, 266, 276 and 286. In other words, the relationships in the set Income goals for different time intervals for the Reference Month will be at least initially automatically mirrored in all other months in the rental time period.

As illustrated in FIGS. 6 and 7A, the actual expected or goal Income for different months in the rental time period may differ from each other in one or more embodiments. The percentage entry 771 for the month of July, 2020 in FIG. 7A and exemplary monthly entries 671 and 672 for the months of July and May 2020 in FIG. 6 indicate the percentage relationship of the expected Income for each respective month to the Reference Month. The monthly percentage for the Reference Month is 100% because it refers to itself, but for the non-Reference Months it may be driven and determined based on the market analysis of the Rental Services provider, independent market research and analysis, or multiple sources. For example, the default or expected Income rates for the month of January in the Hamptons might be 20% of the expected August Income, and the expected Income for the month of July might be 95% of the August (the Reference Month) expected, estimated and/or the goal Income.

As described above, manual changes (which could be made by the user in some embodiments) to the Reference Month entries will cause the system to recalculate and reset the modified relationships and/or ratios for the other months in some embodiments of the invention. In other embodiments, the user may indicate to the system (for example by a check box, a menu option or a button) not to make the automatic recalculation, and apply changes in the Reference Month time entries only for that month alone, without triggering the automatic recalculations and application of the modified ratios to other months in the rental period.

In one or more embodiments, the user may manually change goals and relationship of the estimated Income entries for different time periods for any non-Reference Month. In some embodiments, the user might manually modify any entry for the duration period for the non-Reference Month. For example, the change in the goal or expected Income for the Two-week time period 721 for the month of July, 2020 in FIG. 7A may be used as the “driver entry” for that month. This change to the non-Reference Month entry will not cause the system to recalculate Income entries for other months, but may change the relationship between the time entries for that month only. In some embodiments, the user may also be presented with an additional settable option (i.e., a check box or a pull down menu, or a button) to make the modified month (i.e., July, 2020 in FIG. 7A) the new Reference Month, and thereafter trigger the system to make an automatic adjustment to the time entries for all other months, based on the changes in the relationship and ratio of the time entries for the month of July 2020. In other words, the user may modify the actual month that is used as the Reference Month and the Relationship Template, causing the Pricing Strategy Tool to automatically modify other months in the rental time period.

In some embodiments, the system will automatically re-calculate the calculated relationships in the Income values between the time periods in the non-Reference Months when there is a change in the Reference Month entries. If, on the other hand, the user modifies the relationship and ratios by changing the Income values for a non-Reference Month, the user-changed relationship between the Income goals for different time intervals remains only for that non-Reference Month, and no other months' entries are recalculated and changed.

Monthly “Income” Calculation

In one or more embodiments, the estimated Income for a month is calculated based on the nightly rates for the entire month. This calculation implies a check-in on the first day and a check-out on the last day, after the Length of Stay Discount (discussed below) is applied. For example, a particular Month's entries for January 2020 may have a nightly rate of $100 per Midweek night and $250 per Weekend night. It may also identify the Jan. 1 2020 as a Premium Night, with a higher rate of $500. January 2 2020 may have an Adjusted Rate (i.e., changed by user) of $400. The length of stay discount may be calculated at 40%.

Based on these settings, January 2020 includes the following in the Income calculations:

a) 8 weekend nights (checkout is Friday January 31^{st})

b) 20 midweek nights (excluding the premium and adjusted rate nights)

c) 1 premium night (January 1^{st})

d) 1 adjusted rate night (January 2^{nd})

Thus, the Income for January 2020, before the discounts, may be calculated in one or more embodiments as (8×250)+(20×100)+(500)+(400)=$4,900. After applying the Length of Stay discount (discussed below) of 40%, January 2020 estimated Income is $2,820. This estimated Income may be presented to the user as part of the settings and data for the month.

In one or more embodiments, when the user adjusts a specific date Income or changes a Premium Night status for some date, the overall month total is auto-calculated or recalculated by the Price Strategy Tool to include and account for the new adjustment.

Automatic Recalculations Based on a “Driver” Entry for the Month

When the user adjusts any specific value for the month, two weeks, week, weekend or mid-week entries for a specific month, the remaining rates for that months are adjusted to match the new value entered by the user. The process of re-calculating the new rates is done by creating a percentage of change between the previous values to the new value and applying this percentage to the remaining of the fields. The only exception is the month income which is calculated based on the nightly rates (see below). Because the month value is calculated based of the actual monthly estimated Income, if the month value was changed, the difference percentage is applied for the nightly rates and the month total is re-calculated repeatedly until the monthly total matches the new entered value.

### Example A

For example, the initial January settings may have the following values:

| Month | Two Weeks | Week | Weekend | Mid-Week |
|---|---|---|---|---|
| $14,722 | $5,000 | $2,500 | $1,250 | $750 |

If the user adjusted the Week entry value for the month of January to $3,500, which is 40% of the original $2,500, the new estimated Income entries for other time periods, except for the Month Income, will be automatically adjusted for the month of January.

| Month | Two Weeks | Week | Weekend | Mid-Week |
|---|---|---|---|---|
| $20,611 | $7,000 | $3,500 | $1,750 | $1,050 |

The Month Income estimate or the goal (i.e., $20,611) is calculated in one or more embodiments, as discussed above under the “Monthly Income Calculation” heading, based on the nightly rates for the entire month, taking into account the Premium Nights estimated Income, Adjusted Rate Nights (i.e., modification based on the user changes) and applying the Length of Stay discount adjustments.

### Example B

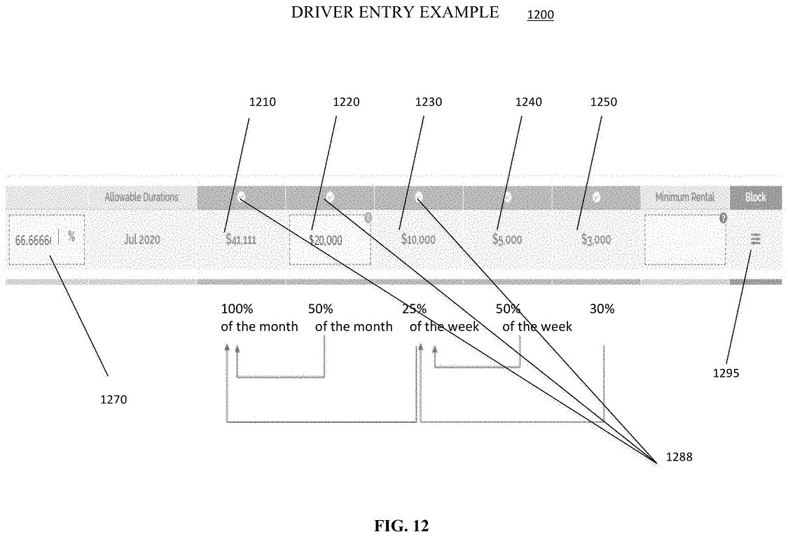

The adjustment for a specific month's entries may be based on a “Driver” entry for that month, as further described with reference to the Driver Entry Example 1200 illustrated in FIG. 12. The estimated Income or the goal Income entries are shown for the month of July 2020, which is a non-Reference month. The owner may indicate the desired Income amount or goal for a Two-week entry 1220. In this example, the user indicated and entered the goal Income amount of $20,000 for the Two-week entry for July 2020.

Instead of calculating what would be a per week value, and then what percentage that is of an August Week entry (the corresponding time period for the Reference Month), the system allows the user to select any time period cell as a “driver” for that month. The selected “driver” time entry is then used by the pricing tool software and system to change and recalculate the monthly weight for the month 1270 with respect to the Reference Month and will further cause the system to change other entries for the month based on the entered “driver” amount. For instance, if the user changes the “driver” field (e.g. week), the month weight in relationship to the Reference Month is re-calculated to match the entered value for the “driver entry”. Based on the new weight value, the month and other fields are re-calculated for that month. Thus, the “driver” entry will dictate the amounts that the system will automatically enter and/or modify for the other estimated or goal Income values for the month.

In one or more embodiments, the Income setting for the Month entry is not exclusively driven by the “driver” entry. Instead, the system may populate and calculate the full monthly calendar (all available nights) with the per-day estimated income values based on the “driver” entry, and factor in and calculate the Week Night and Weekend pricing. Moreover, the Pricing Strategy Tool software will also factor in the Premium Nights pricing and apply the Length of Stay discounts, and then calculate the resulting Month Income entry 1210. As illustrated in FIG. 12, the calculated value for the Month Income entry for July 2020 is not $40,000. Thus, the Month Income entry is not calculated exclusively by the “driver” entry value. Instead, in one or more embodiments, it is calculated by factoring in at least some of the above adjustments. Thus, it may calculate a value of $41,111 for July 2020 in accordance with one or more embodiments.

Allowable Duration Indicator and Blocked Month Features

In one or more embodiments, the system and the user interface may allow the user to select the allowable durations for each month and/or time period in each month. In some examples, the Graphical User Interface may include a separate bar for each month in the rental period. Referring to FIG. 12, the user may check only the settable boxes or virtual buttons 1288 over the Month entry 1210, the Two-week entry 1220 and the Week entry 1230, indicating that the property is not available for any duration shorter than a week. Alternatively, the user may only check Weekday entry 1240, indicating that the property is unavailable on weekdays, and may rented only for weekends.

The system may also allow the user to check or click on box or virtual button 1295, to block the entire month during the otherwise available rental period. This feature allows owners and their agents to quickly modify the availability calendar when the owner wants to use the property for his or her own user, or makes a short-term rental arrangement with another person during the rental period. The system not only allows the user to quickly make the adjustments and indicate changes, but will also automatically recalculate the estimated and goal Income for the remaining rental period, taking into account the blocked or unavailable settings.

Suggested Rate Feature

In one or more embodiments, the system may provide a “Suggested Rate” feature for any one of the estimated or goal Income fields. For example, in any given month during the rental period, the user can click on a Suggestions button (or a pull down menu setting, or select a Help or some other pull down menu or setting or icon) and view the suggested Income for that field or length of stay booking for that month. The suggested rates can be based at least partially on the market analysis for similar properties in size, features, geographic or market areas or prior history for the property (or neighboring properties), or a combination of such factors.

Length of Stay Discount

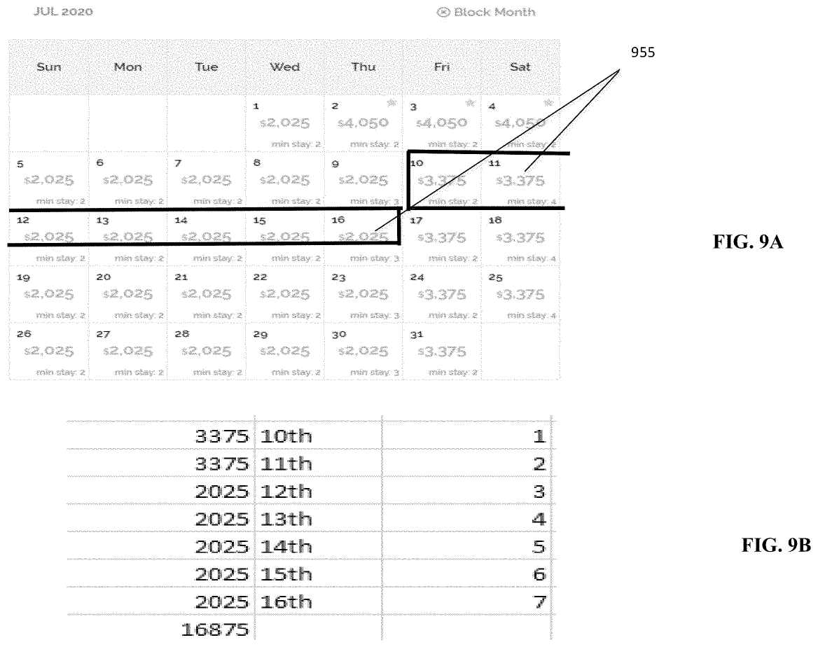

The Length of Stay (LOS) discount feature may be implemented in one or more embodiments as explained with reference to FIGS. 8 and 9. One or more embodiments may implement and apply the LOS discounts to the Monthly Income estimates or goals based on different factors or in accordance with the user input. Thus, the LOS discount percentage can be either automatically calculated by the system or manually entered by the user. In some embodiments, the automatic calculation of LOS applies the total Standard Nightly Rates or Nightly Rates for the entire monthly period (added day by day) and compares to the entered amount under the Reference Month for the same period.

For example, if the user enters $50,000 for the month, the total Nightly Rates for the month adds up to $101,400 (including all Premium Nights and Adjusted Rates). Accordingly, the month discount can be calculated and set as follow:

(1+((101,400+50,000)/101,400))*100=49.7%

Referring to FIG. 8, the Pricing Strategy Tool may apply the indicated default values for the LOS pricing discounts, or may apply owner-provided values for different lengths of stay. As shown, the full month rental 820 (over 28 days) will include a 25.9% LOS discount 825, while a shorter weekly rental 810 (7 days) will include a 20% LOS discount 815.

Referring to FIGS. 9A-B, if a renter checks in on July 10^{th} and checks out on July 17^{th}, renting the property for 7 nights, the total calculated amount for all nights, before the LOS discount is calculated by the Pricing Strategy Tool to be $16,875, as indicated in FIG. 9B. After applying the 20% discount, as indicated in FIG. 8 for the 7-day stay, the adjusted total or estimate for the rental period is $13,500. The LOS discount feature allows the owner to reward and indicate the specific estimated discounts to the renter based on the entered rental period. In fact, the Pricing Strategy Tool may offer the renter a suggestion to increase the stay and obtain the LOS discount when appropriate. It also allows the owner to set a better pricing strategy for the property, with adequate rewards for longer stay and adjustments for the extra expenses that may be accounted for a shorter stay periods (for example, cleaning, housekeeping, insurance, faster depreciation, etc.)

Minimum Rental Amount Feature

Referring to FIG. 11, one or more embodiments of the present invention may also include and provide a Minimum Rental Amount value 1155, settable by the user. The minimum rental value is used to establish additional Minimum LOS requirements. For example, if the Minimum Rental Amount is not met in the default 2-nights LOS, the LOS requirements are changed to a longer Minimum LOS setting.

The owner and the Price Strategy Tool software will determine a minimum amount that a booking would need to reach in order for the owner to be interested in taking the booking offer. For example, based on the Monthly weights for the Reference Month, the nightly rate for a weekend in May 1185 is only $1,350. It may be not worth it for the owner to ready his or her entire property for a booking that will only net around $2,400. Thus, by setting the minimum rental value to $3,000, the system will reset the Minimum LOS for the indicated dates to a 3-day minimum stay, accommodating the owner's goals for the set period.

Minimum Monthly Income

In accordance with one or more embodiments, the user can also enter and set a Minimum Monthly Income for any month in the selected date range. When the user enters a Minimum Monthly Income amount, the Pricing Strategy Tool may automatically adjust the Minimum Length of Stay values (as discussed above) to meet the goal of Minimum Monthly Income. The Pricing Strategy Tool may also automatically recalculate the estimated or goal Income for each date in the month based on the “nightly rate” for each date in a way that would meet the user's set Minimum Monthly Income amount value.

For example, if the user enters $1,000 as the Minimum Monthly Income for January, the minimum 2-day rental rates for the property may be set to the January 1^{st} “nightly rate” of $750, and the January 2^{nd} to January 5^{th} “nightly rate” is $400 per night. A booking starting on January 1^{st} will require a minimum length of stay of two nights (total two nights booking=$1,150, minus any LOS discounts, if any) If there are no LOS discounts (which is typical for a two-night stay), the estimated revenue meets the owner's set goal of Minimum Monthly Income of $1,000. A booking starting on January 2^{nd}, on the other hand, will required a minimum length of stay of three nights (total three nights booking=$1,200, minus any LOS discounts, if any), which also meets the indicated Minimum Monthly Income.

In one ore more embodiments, the user may enter a value for any duration of stay that is less than 31 nights in order to generate the LOS discount. Thus, a present system may have as many as 31 LOS discounts. As described, the month, 2-week, week, weekend and midweek time periods are examples of the set time periods for one or more embodiments, and other lengths of stays periods may be used in accordance with other embodiments of the invention.

Calendar Display

One of the features of the present invention, in one or several embodiments, is the monthly calendar display, with settable fields, as illustrated in FIGS. 7B, 9A and 11. Under the monthly settings, the user can adjust any specific date in the selected range for specific changes. Each month may be displayed in a calendar format, with a Nightly Rates value and a Minimum LOS value setting indicator for that specific date. Referring to FIG. 3, the user can click on a date and change the Income for the Nightly Rate 350, Minimum LOS 360 or disallow check-ins 330 or check-outs 340 on that date.

The user can also set or flag any date in the calendar display as an “available” or “unavailable” (blocked) night. For example, the user can click on July 4^{th}, type in a new rate of $2000, select a minimum length of stay of 4 nights for the booking, starting on July 4^{th}, allow check-ins, and disallow check-outs. The disallowing of check-outs is an important feature for the owners who are unable to send a representative or agent on a weekend or holiday, and therefore can't check the property at the check-out on such days.

In the calendar daily setting and/or display, the Premium Nights might be highlighted with an icon or have a different color or background, and any adjusted rates or Minimum LOS settings that have been adjusted (either by the user or automatically changed by the Pricing Strategy Tool) may be highlighted with a different color, background or indicated with some reference symbol. This feature would help the user quickly find any previously made changes and/or find the Premium Nights quickly, as he or she scans through the calendars.

In one or more embodiments, when the user adjusts a specific date Income or changes a Premium Night status for some date in the calendar display, the overall month total is auto-calculated or recalculated by the Price Strategy Tool to include and account for the new adjustment.

Auto-Notification

When a user blocks a night or a month, any dates with a minimum LOS that will exceed the blocked date(s) will be rendered unbookable. For example, if a user blocked May 12^{th} and the month of May has a minimum LOS settings of 14 nights, then May 1^{st} to May 11^{th} will be unbookable. The same rule will apply for April if any date has a minimum LOS that passes May 12^{th}.

In one or more embodiments, a small notification will appear on the bottom of the screen or the monthly calendar display in the GUI for the user settings in order to bring this issue to the user's attention. Additionally or alternatively, the calendar dates may be highlighted or marked as unbookable for those dates in the monthly and yearly calendar displays. They system may allow the user to click on the displayed “blocked dates” notification or indicator. The system may then display the blocked dates for the user to review, and may either suggest adjusting the minimum stay settings for the previous dates or unblocking the date, and/or perform the adjustment automatically after the user's selection.

In one or more embodiments, when the Automated Price Strategy Tool determines that the minimum LOS set by the user for a particular day or time period makes a check-in impossible because of a blocked date that interferes with the set LOS requirement, the processor on the server 490 of the listing service provider may send an automatic notification (either as a displayed XML or HTL, through an email, SMS, text or through any other known communications using the Internet or computer network) to the user device. The notification may include an explanation of the problem with the user setting, and may provide a suggestion on how to fix the problem. For example, it may suggest removing the blocked date that interferes with the LOS setting inputted by the user. Alternatively, it may suggest modifying the LOS setting for a particular date or period set by the user.

The above embodiments and illustrative descriptions of the application of the principles of the present invention are intended to enable a person skilled in the art to make or use the disclosed invention. They are not intended to be either exclusive, exhaustive or limiting on the scope of the invention described and claimed herein.

Other variations or modification could be used and applied by a person skilled in the art without deviating from the scope and spirit of the present invention. Such modifications and alternative arrangements are not intended to be outside the scope of the present invention and are intended to be covered by it. The invention title and abstract are not intended to limit the claimed invention or cover multiple embodiments and all various features of the claimed invention.

I hereby claim:

1. An automated computerized system for placement and management of rental properties comprising:
a user device having a processor, memory and a display screen;
at least one processor executing a plurality of computer instructions stored in memory, causing the processor to communicate with the user device for:
receiving at least one rental property listing from the user device;
receiving data indicating availability of the at least one rental property and calculating a rental period based on the availability data;
receiving a price data for a first time period entry in a Reference Month, wherein the Reference Month is selected based at least partially on a market data for a geographic location of the received rental property listing;
applying and utilizing the received price data for the first time period entry to calculate one or more price values for other time period entries in the Reference Month in accordance with a pre-determined relationship for the plurality of time period entries in the Reference Month;
applying and utilizing the ratios between prices for different time period entries in the Reference Month to calculate a plurality of corresponding price data values for corresponding time period entries in at least one non-Reference Month, wherein the same ratios between prices for different time period entries in the Reference Month are applied to the corresponding time entries for the at least one non-Reference Month;
determining an estimated monthly income for the Reference Month and the at least one non-Reference Month; and
transmitting the calculated price values for the Reference Month and the a least one non-Reference Month for display on the user device.

2. The system of claim 1, wherein the user device is a mobile phone, a laptop computer, an electronic pad, a desktop computer or a TV set equipped with Internet access, and wherein the at least one rental property listing includes one or more photographs and at least one video of the listed property.

3. The system of claim 1, wherein the Reference Month is automatically selected as a month with a highest expected rental income based at least partially on a market data for a geographic location of the received at least one rental property.

4. The system of claim 1, wherein the price data for the first and other time period entries for any month in the rental time period include prices for a month rental, two week rental, one week rental, weekend rental and mid-week rental.

5. The system of claim 1, wherein the said at least one processor executes a plurality of computer instructions stored in memory for:
determining at least one Premium Night price to rental during a calculated rental period;
determining a length of stay discount;
applying the at least one Premium Night price and the length of stay discount to the calculation of an estimated monthly income for the Reference Month or the non-Reference Month.

6. The system of claim 5, wherein the said at least one processor executes a plurality of computer instructions stored in memory for:
determining at least one Adjusted Rate based on a data from a user;
applying the at least one Adjusted Rate with the Premium Night price and the length of stay discount in the calculation of an estimated monthly income for the Reference Month or the non-Reference Month.

7. The system of claim 6, wherein the received data from the user device includes a minimum length of stay information, and the minimum length of stay information is utilized to determine availability of the rental property for at least one time period entry for any month and for calculation of the price for at least one time period entry in any month.

8. The system of claim 7, wherein display of the calculated price values on the user device includes presentation of a monthly calendar with a calculated nightly price for each day on the calendar in the allowed rental period, indication of the Premium Nights and Adjusted Rate, and a minimum length of stay value for the minimum length of stay associated with each calendar entry.

9. The system of claim 1, wherein the received data from the user device includes a minimum monthly income information, and the minimum monthly income information is utilized to determine availability of the rental property for at least one time period entry for any month.

10. The system of claim 1, wherein the user provides all price information for each time period entry in the Reference Month, and the provided price information defines the Relationship Template for all non-Reference Months, wherein the ration of prices in a plurality of time period entries for at least one non-Reference Months is automatically calculated based on the defined Relationship Template.

11. The system of claim 1, wherein the said at least one processor executes a plurality of computer instructions stored in memory for:
providing a suggested price for one or more price values for other time period entries, other than the first time period entry, in the Reference Month in accordance with a pre-determined relationship for the plurality of time period entries in the Reference Month and market data.

12. A method of providing placement and management of rental properties comprising:
receiving at least one rental property listing from a user device;
receiving data indicating availability of the at least one rental property and calculating a rental period based on the availability data;
receiving a price data for a first time period entry in a Reference Month, wherein the Reference Month is selected based at least partially on a market data for a geographic location of the received rental property listing;
applying and utilizing the received price data for the first time period entry to calculate one or more price values for other time period entries in the Reference Month in accordance with a pre-determined relationship for the plurality of time period entries in the Reference Month;
applying and utilizing the ratios between prices for different time period entries in the Reference Month to calculate a plurality of corresponding price data values for corresponding time period entries in at least one non-Reference Month, wherein the same ratios between prices for different time period entries in the Reference Month are applied to the corresponding time entries for the at least one non-Reference Month;
determining an estimated monthly income for the Reference Month and the at least one non-Reference Month; and
transmitting the calculated price values for the Reference Month and the a least one non-Reference Month for displaying on the user device.

13. The method of claim 12, wherein the Reference Month is automatically selected as a month with a highest expected rental income based at least partially on a market data for a geographic location of the received at least one rental property.

14. The method of claim 12, wherein the receiving of the price data for the first and other time period entries for any month in the rental time period include prices for a month rental, two week rental, one week rental, weekend rental and mid-week rental.

15. The method of claim 12, further including:
determining at least one Premium Night price to rental during a calculated rental period;
determining a length of stay discount;
applying the at least one Premium Night price and the length of stay discount to the calculation of an estimated monthly income for the Reference Month or the non-Reference Month.

16. The method of claim 15, further including:
determining at least one Adjusted Rate based on a data from a user;
applying the at least one Adjusted Rate with the Premium Night price and the length of stay discount in the calculation of an estimated monthly income for the Reference Month or the non-Reference Month.

17. The method of claim 16, wherein the receiving of the data includes receiving a minimum length of stay information, further including the steps of
utilizing the received minimum length of stay information to determine availability of the rental property for at least one time period entry for any month, and
calculating the price for at least one time period entry in any month.

18. The method of claim 12, wherein the displaying calculated price values on the user device includes presentation of a monthly calendar with a calculated nightly price for each day on the calendar in the allowed rental period, identification and indication of the Premium Nights and Adjusted Rate on the display, and displaying a minimum length of stay value for the minimum length of stay associated with each calendar entry.

19. The method of claim 12, wherein the receiving data includes receiving a minimum monthly income information from the user device, and further includes utilizing the received minimum monthly income information in determining availability of the rental property for at least one time period entry for any month.

20. The method of claim 12, further comprising providing a suggested price for one or more price values for other time period entries, other than the first time period entry, in the Reference Month in accordance with a pre-determined relationship for the plurality of time period entries in the Reference Month and market data.
